(19) United States
(12) Patent Application Publication
(10) Pub. No.: US 2007/0239827 A1
(43) Pub. Date: Oct. 11, 2007

(54) Global chat system

(76) Inventors: Scott Deboy, Hillsboro, OR (US); Kenneth Majors, Lake Oswego, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/705,849

(22) Filed: Feb. 13, 2007

Related U.S. Application Data
(60) Provisional application No. 60/772,765, filed on Feb. 13, 2006.

(51) Int. Cl. G06F 15/16; G06F 3/00

(52) U.S. Cl. 709/204; 715/758

(57) ABSTRACT

A chat system.

### CROSS REFERENCE TO RELATED APPLICATIONS

This application claims the benefit of Provisional Application Ser. No. 60/772,765 filed Feb. 13, 2006.

### BACKGROUND OF THE INVENTION

The present invention relates to a network based chat system including a plurality of clients and a server.

With the increasing computer performance and the adoption of computer networks, such as the Internet, joint communications over the computer network has become widespread. Chat systems using the computer network have become prevalent. The chat systems permit text messaging, audio communication, and video communication between a plurality of users. The chat systems are more interactive for effective communication in comparison to electronic mail. Examples of such chat systems include Yahoo Messenger and MSN Messenger.

In conventional chat systems, a client workstation is connected to a predetermined channel of the conventional chat system. During a chat session between a plurality of client workstations and a server computer, the user is able to view the contents of talks or chats in the chat session in real time, such as shown in FIG. 1. In addition, a log file containing chat records is produced when the client workstation is connected to the channel of the chat system, the user is able to store the log file in a memory of the client workstation so that the user can later view the contents of the stored file.

### BRIEF DESCRIPTION OF THE SEVERAL VIEWS OF THE DRAWINGS

FIG. 1 is an illustration of a chat session.

FIG. 2 is a diagram of a computer network to which a communication management system.

FIG. 3 is a diagram of a computer network to which a communication management system.

FIG. 4 illustrates a website with a chat interface.

FIG. 5 illustrates a client-server and peer-to-peer chat network.

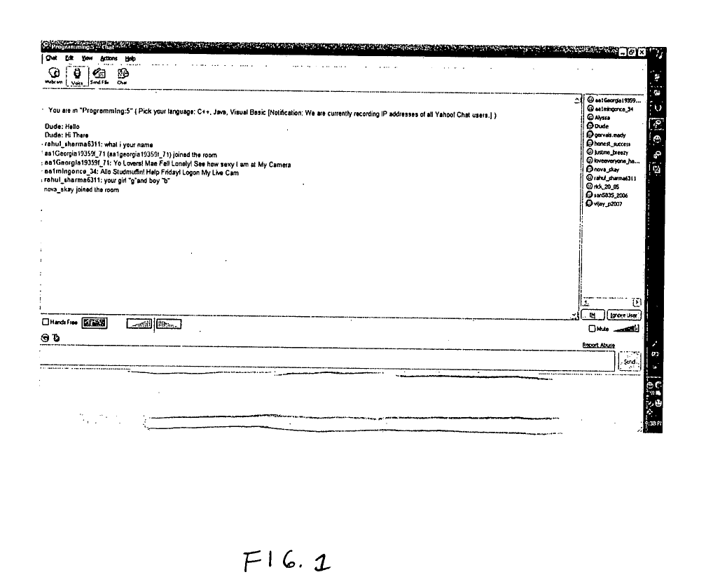

### DETAILED DESCRIPTION OF PREFERRED EMBODIMENT

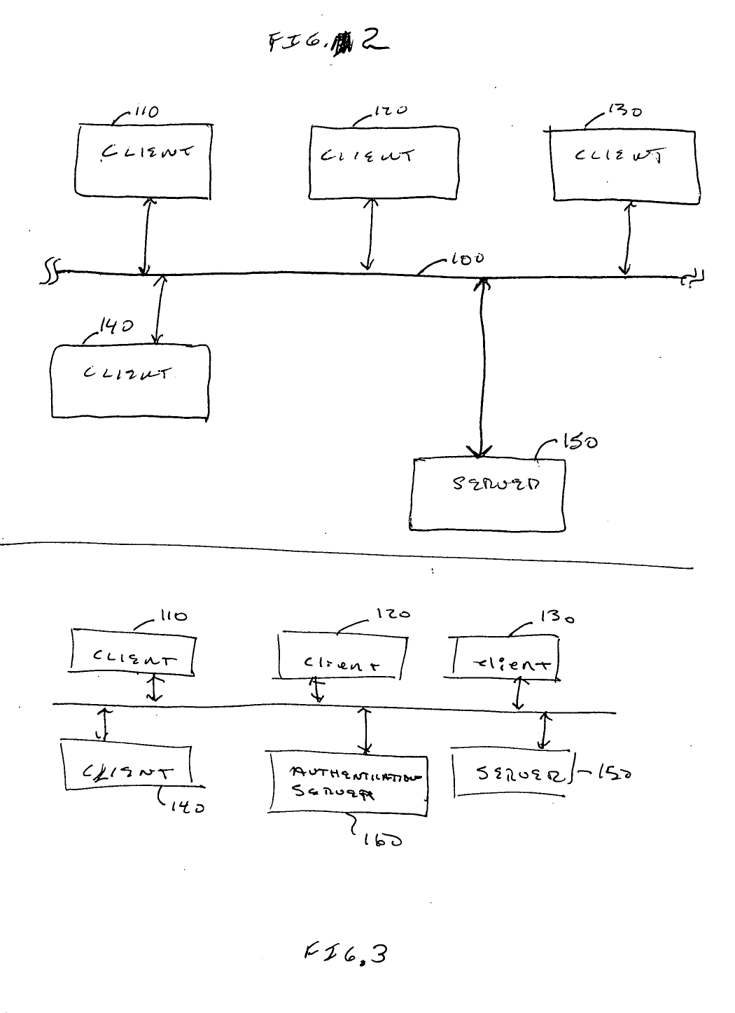

FIG. 2 illustrates a computer network with a chat system. As shown in FIG. 2, the computer network 100, such as a local area network (LAN), a wireless network, or the Internet, includes a plurality of client workstations 110, 120, 130, 140, and a server computer 150 which are linked together by the network 100. The network may be a wired network, wireless network, wide area network, or a combination of the above. The computer network of FIG. 2 is illustrated to give a typical example of the configuration of the computer network. A chat system is provided in, for example, the computer network of FIG. 2, and enables a user of the client workstation of concern linked to the computer network to carry out a chat among a plurality of users of the other client workstations and the server computer.

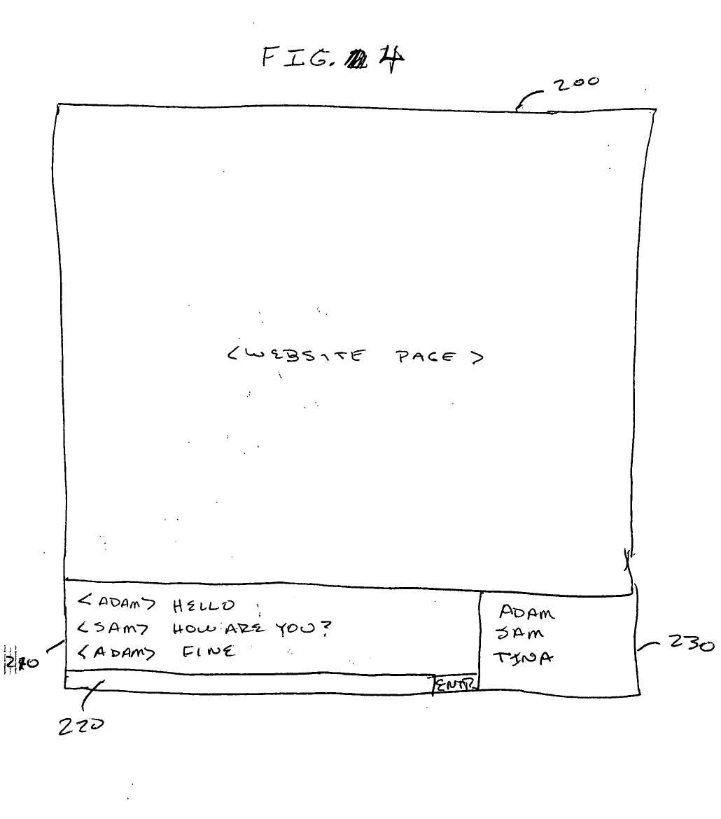

The users may authenticate the chat session by logging onto the server where the user provides a user name and password, if desired. The users may likewise select a chat channel from the server. In this manner, multiple users may effectively join a chat session. Preferably, the server is an audio video conferencing server. Referring to FIG. 3, the system may include an authentication server 160 that authenticates each user, which thereafter sends messages to and from the server.

The chat system provides a plurality of channels. For example, a user of the client workstation 110, which is connected to a certain channel of the chat system, can view on a monitor of the workstation 110 the contents of the chat among the client workstations which are connected to the same channel of the chat system. During the chat session, the user of the client workstation 110 inputs text indicating his own talks, using an input device of the client workstation 110, and the text input by the user is transmitted through the computer network to all the client workstations connected to the same channel of the chat system.

The chat system may produce a log files of one or more channels of the chat system during a chat session between the plurality of client workstations and the server computer.

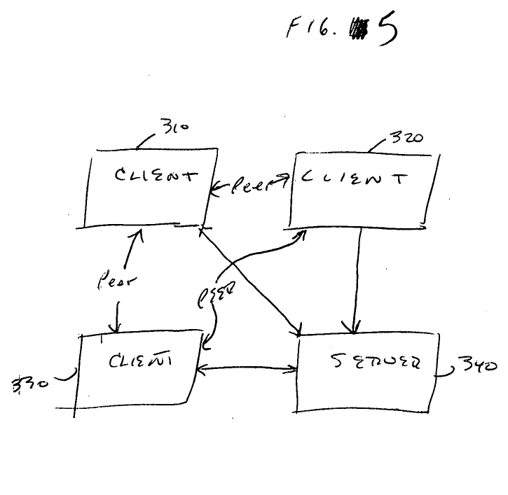

FIG. 4 illustrates a website 200 that may present any desirable content, typically in a browser. A plug-in to the browser 200 or any other suitable program may be used to provide a textual region on the user's display. The textual region provides a region of the user's screen upon which may be displayed a chat session. The textual region may display text messages and other users that are likewise in the same chat session. The server may define the chat session by the URL to the website, URL to the domain, a location or indicator, or other identifier. With any manner of identifying a particular chat session different users who are currently viewing the website 200 may communicate with one another as facilitated by the server 150. In this manner, different users may discuss a website currently being viewed though a chat mechanism.

The user types chat messages in a chat window 210 which is provided to the server 150. The server 150 in turn automatically provides the chat message to other users of that chat channel. This enables users to send and receive messages among themselves while viewing a website 200. A window 220 may be provided for the user to input a text message. A window 230 may display the users that are currently viewing the website and signed in to the chat session with the server 150.

Messages may be stored by the server 150 in a database where the message is associated with the website. In another implementation, to update the messages 210 and current users 230 associated with a particular website the user's computer may periodically queries the server 150 to obtain additional message information for the currently viewed website. Unfortunately, for a large number of users the periodic queries to the server 150 may tend to overwhelm the capabilities of the server 150.

As the user changes to different websites the currently viewed website by the user is provided to the server 150. The user is automatically changed from a chat session relevant to the previous website and connected to a chat session relevant to the new website. In this manner, the user is able to freely move from location to location and automatically be interconnected with other users.

Referring to FIG. 5, a modified technique for configuring a chat conference involves client computers 310, 320, 330 authenticating by communication with the server 340. In this manner, the clients 310, 320, 330 log into the chat system using their user name and password. In this manner, the user may have a persistent user name. The server 340 may provide the clients a list of current viewers for a particular website 200. In addition, the server 340 may provide the messages for each particular website 200 to the appropriate viewers.

The use of a website or other location for identification of information that may be of joint interest among a group of users is an appropriate technique for the joining together users. By way of example, the users may be grouped by the main domain (www.amazon.com) or by a sub-domain such as (www.amazon.com/snowboards/) or both. In addition, the server 340 may permit the users to enter a text identifier for the chat room.

To sign into the chat functionality, preferably the users authenticate with the server 340. If desired, the system may permit the users to use an anonymous login name or a stateful name that is persistent between logins and identified with a particular user. The chat location may be associated with a currently viewed website or otherwise identified by a textual identifier. Since the server 340 is used for logins and website identification, a set of chat room preferences for a particular viewer may be stored on the server 340. The user may add to the stored chat preferences, re-order the chat preferences, and delete stored chat preferences.

In many cases the client communication with the server 340 may be generally in a client-server manner. In this manner, all of the messages are posted to the server 340 and obtained from or provided by the server 340 for other clients in a particular chat session. In order to reduce the bandwidth requirements for the server 340, to create a more robust network, to reduce bandwidth requirements between one or more clients on a particular local network, and a server 340 outside of the local network, such as on the Internet, the system permits chat communications to also be based upon a peer-to-peer technique.

In many cases the chat system may permit text, audio, and video communication. Different types of communication tend to require different amounts of bandwidth, with video being the most bandwidth intensive. The server 340 may direct the clients to communicate in a peer-to-peer manner to reduce the bandwidth requirements for the server 340. The server 340 may also direct a portion of the communication, such as video and/or audio to be performed in a peer-to-peer manner, while the text is performed in a server client relationship. In addition, the peer-to-peer communication may be text, audio, and/or video. Also, the server 340, or through some coordination mechanism, may facilitate part of the network to communicate in a peer to peer manner for all or part of the data while another part of the network may communicate in a client server relationship for all or part of the data. The addresses (way to communicate with) of different clients may be obtained by the clients by any mechanism, such as for example, a list of client machines posted in an accessible location, an internal list of client machines, or a discovery mechanism.

The preferred peer-to-peer network mechanism uses JXTA which includes a peer-to-peer frame and a network abstraction framework. In many systems, a firewall makes it difficult to connect between different machines because of the limitations in communication. To assist in the communication, a relay operating on a computer accessible over the Internet may be used. The relay may include, for example, HTTP communications or TCP socket communications. The relay normally includes an accessible port to which a client may communicate with in a two way communication. The relay, in turn, provides the communications to the desired destination. In this manner, the user can access other users while being protected behind a firewall.

A software based “rendezvous” program provides a network abstraction and permits a user to provide information about themselves. The information includes how to locate the user. For example, a request is passed to the rendezvous to send information to a particular user, which is passed to appropriate relays to the desired user. Typically a user's private IP address is not published by the rendezvous to other users.

The network configuration may include a distributed hash table, such as a plurality of rendezvous devices together with one or more relays. The hash table may be a loosely consistent distributed hast table (DHT).

The access to the chat functionality may be provided by a toolbar functionality.

The chat functionality provided within the browser may further report to the user, such as in a window alongside the website, a list of the users who are visiting the particular website and/or sub-website. In this manner, the user does not necessarily need to join the particular chat for a website, but nevertheless, is aware of the users that are currently in a particular chat. This permits the user to avoid attempting to chat for website with a limited number of users, or otherwise to many users, or otherwise without the desired users. Hence, the user has the option to selectively not enter a chat for a particular website, while still being able to see who is currently in such chat session.

The user's name may be consistent among all the websites so that the user may have a consistent profile or may be different for particular websites. In addition, by the user having an identify for a particular website they may develop a reputation for providing good information. For example, by visiting often, by providing comments, etc., the user may build karma. As the user builds karma this indication of increased karma may be visible to the other users. A user may likewise grant additional karma to other users, typically for providing good information. In this manner, the system builds some trust.

1. A chat system comprising:
(a) a server;
(b) a plurality of clients;
(c) a communication mechanism to facilitate communication between said server and said plurality of clients associated with a corresponding website of said plurality of clients.
